(19) United States
(12) Patent Application Publication
(10) Pub. No.: US 2025/0058256 A1
(43) Pub. Date: Feb. 20, 2025

(54) SELF-CLEANING FILTERING DEVICE, SYSTEM AND METHOD OF PREPARING A MIXTURE OF LIQUID SULPHUR WITH BENTONITE FOR GRANULATION

(71) Applicant: ZAKLADY CHEMICZNE “SIARKOPOL” TARNOBRZEG SP. Z O.O., Tarnobrzeg (PL)

(72) Inventors: Tomasz BARTMAN, Gorzyce (PL); Lukasz MILO, Zaklikow (PL); Boguslaw KRAWCZYK, Tarnobrzeg (PL); Henryk TURBIARZ, Gorzyce (PL)

(21) Appl. No.: 18/720,340

(22) PCT Filed: Dec. 12, 2022
(86) PCT No.: PCT/IB22/62061

§ 371 Date: Jun. 14, 2024

(30) Foreign Application Priority Data
Dec. 15, 2021 (PL) 439844

(51) Int. Cl. B01D 35/16; B01D 29/66; B01D 35/18

(52) U.S. Cl. CPC B01D 35/16; B01D 29/668; B01D 35/18; B01D 2201/202

(57) ABSTRACT

The self-cleaning filtering device for filtering a mixture of liquid sulfur and bentonite includes a filter cartridge, a tank having an upper section and a lower section separated by the filter cartridge, a heating jacket surrounding the tank, an inlet above the filter cartridge, and an outlet from the lower section. There is an outlet of oversized particles, a steam inlet to the heating jacket, an outlet of condensate, a cover, a bracket on which the filter cartridge is arranged, and a pressure assembly on the filter cartridge having a pressure member and a pressure spring. The pressure member has pressure points on the rim of a pressure ring which are adjacent to the rim of the filter cartridge. The system and method prepares a mixture of liquid sulfur with bentonite for granulation.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The object of the invention is self-cleaning filtering device, system and method for preparing a mixture of liquid sulphur with bentonite for granulation.

### 2. Description of Related Art Including Information Disclosed Under 37 CFR 1.97 and 37 CFR 1.98

The invention relates to technology for preparing artificial fertilizers. Artificial fertilizers are usually supplied to customers in granulated form. A common expectation of the customers is a high quality of the fertilizer, wherein an important factor is that the additives are mixed to an extent that ensures the best possible performance of the fertilizer, namely the composition of the granules should be repeatable and homogeneous. In addition, the granules size should be repeatable.

In known methods of obtaining sulphur-containing fertilizers, bentonite and fertilizer additives are mixed with dry milled ingredients and then granulated at temperatures below the melting point of sulphur. These methods require the use of a binder to bind the individual additives together. There are also known methods of obtaining sulphur fertilizers, which involve mixing bentonite with liquid sulphur and then granulating the mixture in a drum granulator, which use the phenomenon of solidification of sulphur to form granules. The mixture of liquid sulphur and solid additives is fed by a centrifugal pump to a rotary granulator, where it is distributed at a temperature of 120-150° C. by means of a system of sprinkling nozzles, which are used to spray it onto a curtain of already solidified granules. By maintaining the appropriate pre-set temperature inside the granulator, the liquid mixture solidifies on the surface of the granules. Solidification of the mixture can take place in layers on the granules in the air flowing through the granulator.

The proper course of the granulation process depends on obtaining the proper spraying of the liquid mixture, which in turn requires the use of nozzles with appropriate geometry and maintaining the proper and constant pressure of the liquid mixture in the spraying nozzles. Such a process is technologically complicated and in industrial conditions it is difficult to maintain appropriate process parameters. This is caused, for instance, by clogging of the spraying nozzles with solid additives, which are additives of the liquid mixture. These additives are milled, but this does not prevent the presence of oversized solid particles or the formation of agglomerates, i.e. oversized solid particles. It is therefore necessary to prevent such particles from entering the spraying nozzles.

A common problem encountered in the manufacture of granules is clogging of filters caused by undissolved solids suspended in liquid sulphur. Both bentonite and fertilizer additives are not dissolved in liquid sulphur and require careful grinding to form a homogeneous slurry. For this process to be practical, the mixture, which is a slurry of additives such as bentonite and fertilizer additives, must be sufficiently pourable to be pumped into and sprayed out of the granulator nozzles. Unfortunately, in such a process, especially when many additives are used, there is a problem of secondary agglomeration of the additives making it difficult or impossible to pump the mixture through the spraying nozzles. This phenomenon impedes the continuous granulation process.

Used in the sulphur industry, known liquid sulphur filtering devices require that the device should be switched off and opened to remove accumulated contaminants, after the filtration cycle has been completed. The devices are also known to operate intermittently, but do not require opening for regeneration. Regeneration is accomplished by backwashing with liquid sulphur. During backwashing the basic filtration process is interrupted. For the continuity of the main process, therefore, at least two filters are required, with the control system providing for alternating operation of the filters, with one operating and the other being regenerated.

The publication WO2020/163944 discloses a pure sulphur granulation process where a filter is used, wherein a transducer is used which monitors the pressure difference between the two sides of the filter during the process, if a large difference is detected it may indicate that the filter should be replaced or cleaned. The filter described in this publication has heating elements and operates above the melting point of sulphur, wherein this document does not disclose the construction of the filter or the method of regeneration.

Patent description US2016/0229761A1 describes a process for granulating a fertilizer based on liquid sulphur. Disclosed herein is an apparatus for preparing a slurry of a plurality of ingredients, for example, bentonite, humic acids dye fertilizer additives in liquid sulphur. The apparatus comprises a storage tank, a mixer tank with agitator, a transition/pump tank with agitator and a filter, wherein the formation of granules (pellets) is carried out on a rotoformer. The filter used has a mesh size of 140 to 400 mesh which corresponds to 0.105 to 0.037 mm, the description does not specify the method of filter regeneration. Experience has shown that it will clog very frequently, it will require regeneration and the operation of the rotoformer will be periodically interrupted.

Literature states that the outlet diameter of the spraying nozzles should be at least twice the diameter of the largest granules of solids contained in the slurry. However, adjusting the filter to this requirement in the case of liquid sulphur slurry with bentonite did not give satisfactory results even with the introduction of requirements concerning the grain size of the mixture additives, as technological requirements are very important, i.e. the shape of the stream of the sprayed slurry and the amount of the dispersed slurry in the granulator. The installation of a mesh filter with suitable mesh on the slurry discharge pipeline did not give satisfactory results, both for liquid sulphur and sulphur with bentonite, due to the presence of solid particles with larger dimensions and the formation of secondary agglomerates, which led to the clogging of the mesh, the system had to be stopped and cleaning of the mesh was carried out. The addition of other additives also led to a large number of interruptions in operation.

The difficulty with the mixture preparation process is that due to the specifics of the medium to be distributed (mixture of liquid sulphur and solid additives, with a temperature of over 120° C.) and the process requirements (maintaining continuity of the process, maintenance-free), it was not possible to use standard filter cartridges.

### BRIEF SUMMARY OF THE INVENTION

The object of the invention is self-cleaning filtering device for filtering a mixture of liquid sulphur and bentonite, comprising filter cartridge, tank having an upper section and a lower section separated by filter cartridge, heating jacket surrounding the tank, mixture inlet arranged above the filter cartridge for feeding the mixture into the upper section of the tank, wherein the axis of the inlet is arranged tangentially to the wall of the tank, mixture outlet for removing the mixture ready for granulation from the lower section of the tank arranged above the filter cartridge, an outlet for oversized particles, steam inlet for feeding steam to the heating jacket, condensate outlet for collecting condensate generated from steam, tank cover, bracket on which the filter cartridge is arranged, pressing assembly arranged on the filter cartridge, having the pressure member and pressure spring, the pressure member having pressure points on the rim of the pressure ring which is adjacent to the rim of the filter cartridge and the pressure spring being arranged between the pressure member and the tank cover.

The pressure member may be constructed of arches, however, the arches cross each other and the pressure spring rests against the pressure member at the point where the arches meet.

The pressure member may be constructed of a plurality of arches extending radially from the point where the arches connect, and the pressure spring rests against the pressure member at the point where the arches connect.

Preferably, the filter cartridge bracket is formed by an openwork wheel and a cylinder.

The mixture may comprise fertilizer additives.

The invention also provides the system for preparing a mixture of liquid sulphur with bentonite for granulation comprising a mixer of liquid sulphur and bentonite, which feeds the mixture to a pump tank, the pump tank comprising a pump section and a melting section separated by a vertical wall, wherein a flow connection is provided between the pump section and the melting section, and an agitator is arranged in the pump section, wherein the pump tank feeds the mixture to the filtering device and the melting section is connected to the outlet of the oversized particles from the filtering device, self-cleaning filtering device according to the invention, steam supply system for heating the tank of the filtering device.

Preferably, the melting section is provided with a connection to the outlet of the oversized particles formed during the granulation process.

The mixture may include fertilizer additives.

The object of the invention is a method of preparing a mixture of liquid sulphur with bentonite for granulation, by which the liquid sulphur is mixed with the bentonite in a mixer, the liquid mixture is fed from the mixer to a pump tank, the mixture is fed under pressure from the pump tank to the filtering device tank, the temperature inside the filtering device tank is controlled to be higher than the melting temperature of the sulphur, the oversized particles are separated from the filtered mixture in the filtering device tank, the filter cartridge is cleaned by creating a swirl of the mixture directly above the filter cartridge in the tank, wherein the stream flow of the mixture fed by the inlet to the tank is directed tangentially to the wall of the tank, the filtered mixture from the filtering device is fed to granulation, the separated oversized particles are fed to the melting section of the pump tank, the separated oversized particles are melted in the melting section, the mixture formed from the melted oversized particles is fed to the pump section of the pump tank.

Swirls can be produced continuously.

Preferably, the cleaning time of the filter cartridge with the mixture of sulphur and bentonite shall not be less than 5 minutes and the cleaning take place once in at least every 2 hours or more.

The mixture may comprise fertilizer additives.

Preferably, for the mixture of sulphur with bentonite comprising fertilizer additives, the cleaning time of the filter cartridge with the mixture of sulphur with bentonite and fertilizer additives shall not be less than 10 minutes, and the cleaning the cleaning take place once in at least every 1 hour.

Preferably, oversized particles formed during the granulation process are fed into the melting section of the pump tank.

The implementation of the present invention counteracts the phenomenon of blocking of the slurry spraying nozzles in the granulator. The filtering device can be regenerated, i.e. cleaned, without interrupting the operation of the granulator. It is therefore possible to use only one filtering device in a granulator installation to obtain an economical and continuous granulation process.

The use of the system according to the invention for the preparation of the slurry of bentonite and fertilizer additives in liquid sulphur facilitates continuous operation without interruptions for cleaning the filter and decontamination of the slurry spraying nozzles in the granulator. In addition, the installation is resistant to disturbances caused by secondary agglomeration of solid particles suspended in liquid sulphur, oversized particles are returned to the process, thus increasing the efficiency of the process.

### BRIEF DESCRIPTION OF THE SEVERAL VIEWS OF THE DRAWINGS

The invention has been described with reference to an embodiment shown in the drawings.

FIG. 1 shows a schematic view of a diagram of the installation for the production of sulphur granules, bentonite and fertilizer additives.

FIG. 2 shows a schematic view of a cross-section through the filtering device.

FIG. 3a shows a top plan view of the pressure member.

FIG. 3b shows a side elevation view of the pressure member.

FIG. 4a shows a top plan view of the filter cartridge bracket.

FIG. 4b shows a side sectional view of the filter cartridge bracket.

### DETAILED DESCRIPTION OF THE INVENTION

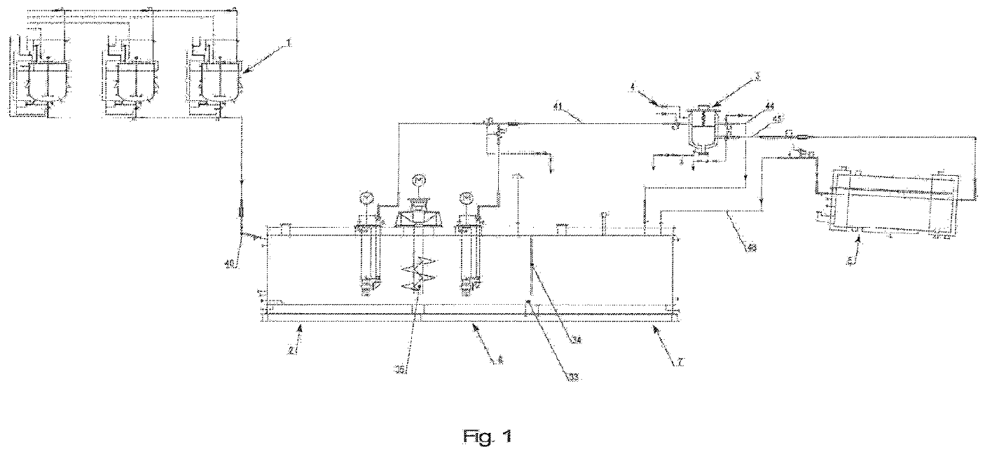

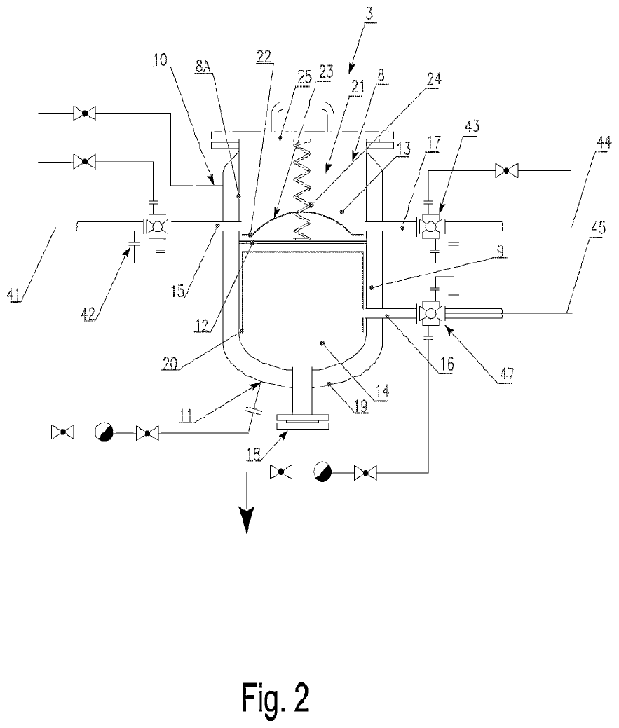

The granulation system shown in FIG. 1 comprises a mixer 1, pump tank 2, filtering device 3, steam supply system 4 and granulator 5. The pump tank 2 comprises pump section 6 and melting section 7. In the embodiment, the mixer 1 is a group of mixers whose outlets are connected to each other, wherein the mixers can operate alternately.

The filtering device 3 comprises a tank 8, which is an inner tank, and a heating jacket 9, which is an outer tank surrounding the tank 8. The heating jacket 9 is adapted to maintain a temperature in the tank 8 where the filtration of the mixture takes place. The heating jacket 9 is provided with a steam inlet 10 to the heating jacket 9 and a condensate outlet 11 from the heating jacket 9 for discharging condensate formed from the steam.

The tank 8 in the filtering device 3 is provided with a mesh in the form of a filter cartridge 12, which divides the tank 8 into an upper section 13 and a lower section 14. The filter cartridge 12 is removable. The tank 8 is provided with an inlet 15 of the mixture, which feeds the mixture into the upper section 13 of the tank 8. The tank 8 is provided with an outlet 16 of the filtered mixture from the lower section 14 of the tank 8. The inlet 15 of the mixture may be in the form of an inlet port, which is arranged in the upper section 13 above the filter cartridge 12. The outlet 16 of the filtered mixture may be in the form of an outlet port, which is arranged in the lower section below the filter cartridge 12. The tank 8 is further provided with the outlet 17 of oversized particles (agglomerates) from the upper section 13 of the tank 8. The outlet 17 of oversized particles may be in the form of a port, which is positioned above the filter cartridge 12. The tank 8 is further provided with the discharge outlet 18 in the lower section of the tank 8, the discharge outlet 18 being used to discharge the mixture from the tank 8. The discharge outlet 18 may be in the form of a discharge port, which is centrally arranged at the lowest point of the bottom 19 of the tank 8, which in cross-section has the form of half an ellipse.

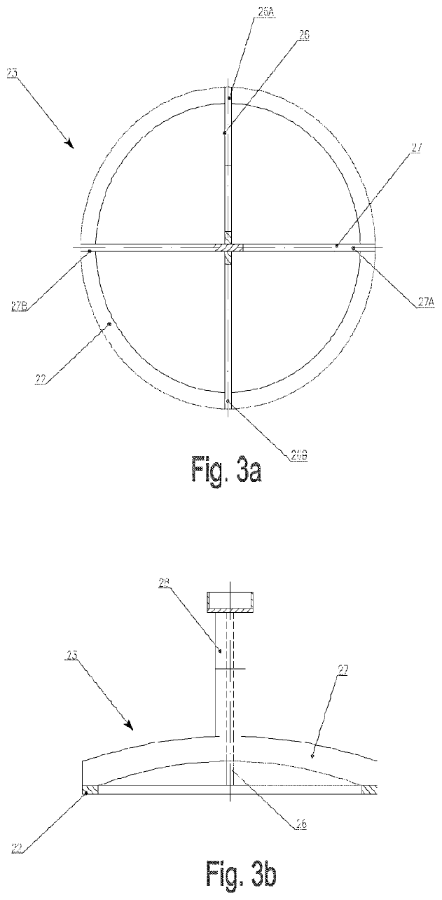

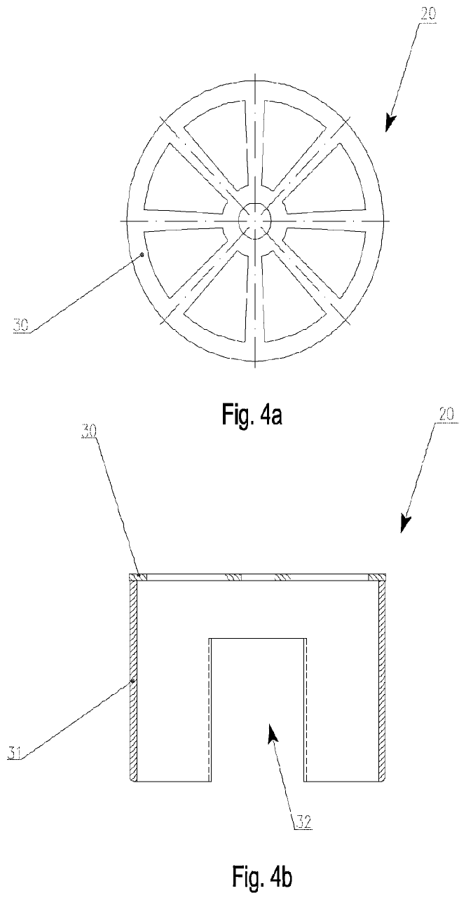

The filter cartridge 12 is a flat screen and has a circular shape. The filter cartridge is made of stainless-steel mesh with a square mesh size of 2×2 mm. The filter cartridge 12 is arranged on the bracket 20, wherein the filter cartridge 12 is pressed against the bracket 20 by a pressure assembly 21. The pressure assembly 21 is arranged at the top of the tank 8 above the filter cartridge 12. The pressure assembly 21 is provided with a pressure ring 22, a pressure member 23 and a spring 24. The tank 8 is closed by the cleanout cover 25, the cleanout cover 25 being provided with a flange closure. The closure of the cleanout cover 25 exerts pressure on the filter cartridge 12 by pressing the spring 24 of the pressure assembly 21. The spring 24 rests on the central section of the cleanout cover 25 and on the central section of the pressure member 23 of the pressure assembly 21. In the illustrated embodiment of the pressing assembly 21, the pressing member 23 (FIGS. 3a, 3b) is in the form of a crossbar comprising two arches 26 and 27, which are connected to each other at the point of intersection of these arches, and the ends 26A, 26B, 27A, 27B of the arches 26 and 27 are resting on the pressing ring 22. The pressure member 23 exerts pressure on the pressure ring 22 at four points and, by means of the pressure ring 22, on the rim of the filter cartridge 12, the pressure member 23 may be provided with more arches and may exert pressure on the pressure ring 22 and the filter cartridge 12 at more points. At the junction point, i.e. the junction of the arches 26, 27, there is a connecting element 28 which connects the arches 26, 27 and on which the spring 24 is placed, therefore the spring 24 rests at the junction point of the arches 26, 27. The arches 26, 27 have a length similar to the diameter of the pressure ring 22. The clearance between the arches 26, 27 and the filter cartridge 12 allows a swirl to form over the filter cartridge 12 above the arches 26, 27. The pressure member 23 may be formed from a plurality of arches extending radially from the point where the arches are connected, and the pressure spring 24 may rest against the pressure member 23 at the point where the arches are connected. In this case, the arches have a length similar to the radius of the pressure ring. The bracket 20 is formed of a horizontally positioned first support element 30 in the form of an openwork wheel coupled to a second support element 31 in the form of a cylinder (FIGS. 4a, 4b). The filter cartridge 12 is adjacent to the first support element 30, which is coupled to the second support element 31. The diameter of the first support element 30 for supporting the filter cartridge 12 may have a diameter in the range of 350 to 400 mm, preferably 390 mm. The openwork first support element 30 allows the filtered mixture to flow through it. The cut-out 32 allows the filtered mixture to be discharged from the lower section 14 of the tank 8 through the outlet 16.

The mixture of liquid sulphur with bentonite and other additives, fertilizer additives is fed into the interior of the filtering device 3 through the inlet 15, wherein the axis of the inlet 15 (inlet port) is directed tangentially to the wall 8A of the tank 8. The mixture is delivered through a pipeline 41, on which a pressure control valve 42 is arranged. The temperature of the fed mixture ranges from 125 to 140° C., this temperature is maintained by the heating jacket 9. The mixture flows into the tank 8 under pressure and is scattered on the surface of the filter cartridge 12, where liquid slurry is separated from oversized particles (thicker grains of bentonite or borax or possibly undissolved clumps of sulphur with bentonite and other fertilizing additives). The cleaned mixture flows out through outlet 16, where pressure is stabilized by pressure control valve 47, and the mixture flows into spraying nozzles placed in granulator 5 through the pipeline 45. The oversized particles with a certain amount of mixture are discharged through the outlet 17 of oversized particles, then they flow through the pressure control valve 43 and are supplied via the pipeline 44 to the melting section 7, the mixture formed after the melting of the particles passes through the flow connection 33 downstream the vertical separating wall 34 to the pump section 6 of the pump tank 2.

The filtering device 3 is designed to be self-cleaning. The self-cleaning of the filter cartridge 12 is achieved by creating a swirl (cyclonic movement) of the mixture in the upper section of the tank 8 above the filter cartridge 12. A cyclonic motion is created by feeding the mixture through the inlet 15 arranged tangentially to the wall 8A of the tank 8, wherein the speed of the mixture entering the filtering device is in the range of 1,5-2.2 m/s. Contaminants that may settle on the filter cartridge 12 are removed by the mixture flowing onto the filter cartridge 12. The resulting swirl of the mixture causes the oversized particles deposited thereon to be detached from the filter cartridge 12, and the centrifugal force causes such particles to be rejected along with the excess mixture through the outlet 17 of oversized particles. The outlet 17 of oversized particles may be constructed as an overflow port from which the mixture containing the oversized particles is discharged into the melting section 7 of the pump tank 2. In the melting section 7 the oversized particles are melted and homogenised again.

The process of preparing the mixture for granulation is initiated in the mixer 1, to which liquid sulphur, bentonite, borax and other fertilizer additives are delivered. The system for preparing the mixture for granulation is provided with at least one mixer 1, and may be provided with several mixers which operate periodically. After the mixing is completed, the prepared mixture flows from the mixer 1 via the pipeline 40 into the pumping section 6 of the pump tank 2 with the use of gravity. Then, under pressure, the mixture is fed through the pipeline 41 into the filtering device 3 tank 8. The tank 8 is heated by the heating jacket 9 to maintain a temperature higher than the melting point of the sulphur. The mixture is fed through the inlet 15 tangentially to the inner wall of the tank 8A, so that a swirl is generated which causes the oversized particles (secondary agglomerates) which have settled on the filter cartridge 12 to be detached. Due to the swirling of the mixture, the regeneration of the filter cartridge (removal of oversized particles) takes place without interrupting the feeding of the mixture to the granulator 5, the filtering of the mixture takes place independently of the swirl generation and in an uninterrupted manner. The mixture is fed to inlet 15 under pressure through valve 42, which is open during operation of the filtering device, the oversized particles together with some mixture are collected through outlet 17. Downstream the outlet 17 there is a valve 43, which can be closed during operation of the device, and during the cleaning of the filter cartridge 12 the valve 43 is opened, which increases the speed of the mixture flow and creates a swirl over the filter cartridge 12. The regeneration of the filter cartridge 12 can be carried out continuously or periodically. Continuous regeneration is carried out by partial opening of the valve 43, i.e. swirl of the mixture is generated, which is maintained during operation of the filtering device 3. Periodical regeneration is realized by periodical partial opening of said valve, i.e. mixture swirl is generated and maintained only for some time. The partial opening of the valve 43 causes a part of the mixture flow, together with oversized particles, to be directed to the melting section 7 of the pump tank 2. The time of flushing the filter cartridge with the liquid mixture in case of mixture with bentonite shall not be less than 5 minutes with frequency not less than once in every 2 hours. In the case of sulphur with bentonite and fertilizer additives, due to the parameters of the mixture and the amount of suspended solids, the flushing time shall not be less than 10 minutes with frequency of not less than once in every 1 hour.

The cleaning process of the filter cartridge 12 can be carried out both continuously, which is optimal in terms of the cleaning efficiency of the filter cartridge and the efficiency of the process, and periodically, which is made possible by the ball valve 43 mounted downstream of the outlet 17 of oversized particles. By fully opening the ball valve 42 upstream of the mixture inlet 15, the maximum flow rate of the mixture fed into the tank 8 can be achieved.

The liquid mixture, after passing through the filter cartridge 12, is fed through the outlet 16 via the pipeline 45 to the granulator 5. The mixture is fed under pressure to the granulator 5, where the mixture is sprayed and granulated.

The separated oversized particles are discharged through the outlet 17 of oversized particles. The oversized particles are fed via a pipeline 44 to the melting section 7 of the pump tank 2. The mixture formed after melting is fed via a flow connection 33 downstream of the wall 34 to the pump section 6 of the pump tank 2. The pump tank 2 is equipped with an agitator 35.

During granulation, oversized particles may be formed, which are fed to the melting section 7 of the pump tank 2 via a pipeline 46 in the same way as the particles separated in the filtering device 3.

We claim:

1. A self-cleaning filtering device for a mixture of liquid sulfur and bentonite, comprising;
a filter cartridge;
a tank having an upper section and a lower section separated by the filter cartridge;
a heating jacket surrounding the tank;
an inlet of the mixture arranged above the filter cartridge for feeding the mixture into the upper section of the tank,
wherein the axis of the inlet is arranged tangentially to the wall of the tank;
an outlet of the mixture for discharging the mixture ready for granulation from the lower section of the tank arranged above the filter cartridge;
an outlet of oversized particles;
a steam inlet for feeding the steam to the heating jacket;
an outlet of the condensate to collect the condensate produced by the steam;
a cover of the tank;
a bracket on which the filter cartridge is arranged; and
pressure assembly being arranged on the filter cartridge and being comprised of a pressure member and a pressure spring,
wherein the pressure member has pressure points on the periphery of the pressure ring which is adjacent to the periphery of the filter cartridge, and
wherein the pressure spring is arranged between the pressure member and the cover of the tank.

2. The device, according to claim 1, wherein the pressure member is formed by arches,
wherein the arches cross each other, and
wherein the pressure spring rests against the pressure member at the connection point of the arches.

3. The device, according to claim 1, wherein the pressure member is formed by a plurality of arches extending radially from the point of connection of the arches, and
wherein the pressure spring rests against the pressure member at the point of connection of the arches.

4. The device, according to claim 1, wherein the bracket of the filter cartridge is comprised of an openwork wheel coupled to a cylinder.

5. The device, according to wherein the mixture comprises fertilizer additives.

6. A system for preparing a mixture of liquid sulfur with bentonite for granulation, comprising:
a mixer of liquid sulfur and bentonite, which feeds the mixture to a pump tank;
a pump tank being comprised of a pump section and a melting section separated by a vertical wall,
wherein a flow connection is provided between the pump section and the melting section, wherein an agitator is arranged in the pump section, wherein the pump tank feeds the mixture to the filtering device, and wherein the melting section is connected to the outlet of oversized particles of the filtering device;
a self-cleaning filtering device, according to claim 1; and
a steam supply system for heating the tank of the filtering device.

7. The system, according to claim 6, wherein the melting section is provided with the connection to the outlet of oversized particles formed during the granulation process.

8. The system, according to claim 6, wherein the mixture comprises fertilizer additives.

9. A method of preparing a mixture of liquid sulphur with bentonite for granulation, the method comprising the steps of:
mixing a liquid sulfur with bentonite in a mixer;
feeding a liquid mixture from the mixer into the pump tank;
feeding a pressurised mixture from the pump tank into the filtering device;
maintaining temperature inside the tank of the filtering device higher than the sulfur melting temperature;
separating oversized particles from the filtered mixture in the filtering device;
cleaning the filter cartridge by generating a swirl of the mixture directly above the filter cartridge in the tank, wherein the stream of the mixture fed by the inlet into the tank is directed tangentially to the wall of the tank;
feeding the filtered mixture from the filtering device for granulation,
feeding the separated oversized particles into the melting section of the pump tank;
melting the separated oversized particles in the melting section; and
feeding the mixture formed from the melted oversized particles into the pump section of the pump tank.

10. The method, according to claim 9, wherein the swirl is generated in a continuous manner.

11. The method, according to claim 9, wherein the cleaning time of the filter cartridge with the mixture of sulfur and bentonite is less than 5 minutes, and wherein the cleaning is once in at least every 2 hours.

12. The method, according to claim 9, wherein the mixture comprises fertilizer additives.

13. The method, according to claim 12, wherein the cleaning time of the filter cartridge with the mixture of sulfur with bentonite and fertilizer additives is more than 10 minutes, and wherein the cleaning is once in at least every 1 hour.

14. The method, according to claim 9, wherein oversized particles formed during the granulation process are fed into the melting section of the pump tank.
